(19) United States
(12) Patent Application Publication
(10) Pub. No.: US 2015/0197368 A1
(43) Pub. Date: Jul. 16, 2015

(54) Corrugated Pallet Top

(71) Applicant: The Corrugated Pallets Company, Toronto (CA)

(72) Inventors: Christopher Gerard Casey, Toronto (CA); Michael Martin MacDonald, Toronto (CA)

(21) Appl. No.: 14/591,752

(22) Filed: Jan. 7, 2015

Related U.S. Application Data
(60) Provisional application No. 61/925,772, filed on Jan. 10, 2014.

(51) Int. Cl. B65D 19/38; B31B 1/26

(52) U.S. Cl. CPC B65D 19/38; B31B 1/26; B65D 2519/00194; B65D 2519/00537

(57) ABSTRACT

A corrugated pallet top and a method of assembling a corrugated pallet top that is produced from a single sheet of corrugated material.

### CROSS-REFERENCE TO RELATED APPLICATIONS

This application claims the priority of U.S. 61/925,772 filed on Jan. 10, 2014.

### FIELD

This disclosure relates to pallet tops constructed using a single sheet of corrugated. Packaging has a need for pallet tops that are new, economically priced and ecologically feasible. A pallet top must be able to maintain a rigid surface, shipped flat to save on storage space, provide a surface that will not damage product and be strong enough to not rip, tear when manual or automated banding/strapping equipment load, wrap and stack product.

### BACKGROUND

Industry uses pallets to ship product to their customers. Pallets are usually stacked three or four high in warehouses. A pallet top provides a flat surface so that it is easier and safer to stack another pallets on top of each other and stops product from being damaged when banding/strapping and or stretch wrap is used to help stabilize loads of product on pallets.

Pallet tops are normally made of wood or corrugated. Wood tops are almost always one piece frame that has been constructed using nails or screws. The rectangular frame creates an edge or bump to cushion the impact from banding/strapping equipment and provides additional product protection when another pallet is placed on it. Corrugated pallet tops are manufactured with one or two pieces of corrugated and always need to be assembled by the end user prior to being placed on a pallet.

The disclosure described herein is fully recyclable, safe to handle, can be manufactured using one die cut scored sheet of corrugated. The complete coverage feature allows the weight from the stacked pallets to be spread over the entire load. End users are not doing assemble work. The pallet tops have a ridge on each of the four edges to provide additional protection for the products being shipped on the pallets.

This pallet top is exempt under ISPM regulations. The significant challenge packaging faces with the use of wood pallet tops is the additional cost both in terms of material and labor using wood to separate pallets stacked on other pallets and the cost to hand assemble by end users one or two sheets of corrugated to form a corrugated pallet top. Damage often occurs from the nails, screws or fasteners used to manufacture wood pallet tops. This design addresses the needs of industry by satisfying these key issues and overcomes the associated disadvantages and shortcomings of known corrugated pallet top designs.

### SUMMARY

The corrugated pallet top described herein addresses the drawbacks evident in other known corrugated pallet tops. This includes a method to assemble the pallet tops economically and removes the labor time-consuming task of assembling the pallet top by the end user. The significant strength and increased load bearing capability of the design illustrated by the four outside edges of the pallet top allows the pallet top to resist compressing or crushing when manual or automated banding/strapping equipment wraps product located on the pallet.

The end user needs previously described can be met by a corrugated pallet top including at least: a single rectangular die cut and scored sheet of corrugated material, having four edges, a top side and a bottom side, each edge having marked adhesive spots on the top side; and each edge having corrugated tabs; the die cut and scored sheet having four external and attached sets of panels, one on each external edge of the rectangular die cut and scored sheet of corrugated material; the four external sets of panels each having three hinged and foldable panels comprising an innermost panel, a middle panel, and outermost panel; and the three panels on each of the four sets of panels having marked adhesive spots on the bottom side of the innermost panel.

The need can also be met by a method for creating a corrugated pallet top including at least: providing a single rectangular die cut and scored sheet of corrugated material, having four edges, a top side and a bottom side, each edge having marked adhesive spots on the top side; and each edge having corrugated tabs; providing four external and attached sets of panels, one on each external edge of the rectangular die cut and scored sheet of corrugated material, with each of the external sets of panels each having three hinged and foldable panels comprising an innermost panel, a middle panel, and outermost panel, and each of the three hinged and foldable panels having marked adhesive spots on the bottom side of the innermost panel; and then for each of the panel sets on the four edges: applying adhesive to each of the adhesive spots on the top side; folding the set of three panels over the top side using hinges between the innermost panel and the external edge so that the innermost panel is pressed onto the adhesive on the adhesive spots on the top side; applying adhesive to each of the adhesive spots on the bottom side of the innermost panel; folding the remaining two panels back over the innermost panel using hinges between the innermost panel and the middle panel so that the middle panel is pressed onto the adhesive on the bottom side of the innermost panel; folding the outermost panel down at a 90 degree angle with respect to the plane of the single rectangular die cut and scored sheet of corrugated material; and locking the outermost panel into place using the corrugated tabs along the edge of the single rectangular die cut and scored sheet of corrugated material.

The disclosure allows the use of a single sheet of corrugated to be folded and glued to replicate the performance of a rectangular frame of a wood pallet top and also have flaps that an one or two piece corrugated pallet top design would need to manually form by an end user. This design is commercially viable alternative to wood pallet tops while performing similar to a wood pallet top.

The unique design of the pallet top using adhesive, hinges and tabs does not require a specific direction of corrugation for the flat die cut and scored corrugated sheet.

### DRAWINGS

FIG. 01 is a perspective view of a flat die cut and scored corrugated sheet.

FIG. 02 is a perspective view of top side of panel 01, panel 02 and panel 03 for Edge A.

FIG. 03 is a perspective view of adhesive applied to Edge A of the top side of the die cut corrugated sheet to adhesive spot 01, adhesive spot 02 and adhesive spot 03.

FIG. 04 is a perspective view of the bottom side of Edge A, Panel 01 folded over using the eight (8) hinges onto adhesive spot 01, adhesive spot 02 and adhesive spot 03.

FIG. 05 is a perspective view of adhesive applied to the bottom side of Edge A, Panel 01 on adhesive spot 04, adhesive spot 05 and adhesive spot 06.

FIG. 06 is a perspective view of the bottom side of Edge A, Panel 02 folding over using the five (5) hinges onto adhesive spot 04, adhesive spot 05 and adhesive spot 06.

FIG. 07 is a perspective view of the top side of Edge A, Panel 03 folding over using the eight (8) hinges to complete the folding and application of adhesive to assemble Edge A.

FIG. 08 is a perspective view of the top side of Edge A, Panel 03 locking into place using three (3) tabs to create a rigid flap design that is unique to this disclosure.

FIG. 09 is a perspective view of the top side of panel 01, panel 02 and panel 03 for Edge B.

FIG. 10 is a perspective view of adhesive applied to Edge B of the top side of the die cut corrugated sheet to adhesive spot 07, adhesive spot 08 and adhesive spot 09.

FIG. 11 is a perspective view of the bottom side of Edge B, Panel 01 folded over using the eight (8) hinges onto adhesive spot 07, adhesive spot 08 and adhesive spot 09.

FIG. 12 is a perspective view of adhesive applied to the bottom side of Edge B, Panel 01 on adhesive spot 10, adhesive spot 11 and adhesive spot 12.

FIG. 13 is a perspective view of the bottom side of Edge B, Panel 02 folding over using the five (5) hinges onto adhesive spot 10, adhesive spot 11 and adhesive spot 12.

FIG. 14 is a perspective view of the top side of Edge B, Panel 03 folding over using the eight (8) hinges to complete the folding and application of adhesive to assemble Edge B.

FIG. 15 is a perspective view of the top side of Edge B, Panel 03 locking into place using three (3) tabs to create a rigid flap design that is unique to this disclosure.

FIG. 16 is a perspective view of top side of panel 01, panel 02 and panel 03 for Edge C.

FIG. 17 is a perspective view of adhesive applied to Edge C of the top side of the die cut corrugated sheet to adhesive spot 13, adhesive spot 14 and adhesive spot 15.

FIG. 18 is a perspective view of the bottom side of Edge C, Panel 01 folded over using the eight (8) hinges onto adhesive spot 13, adhesive spot 14 and adhesive spot 15.

FIG. 19 is a perspective view of adhesive applied to the bottom side of Edge C, Panel 01 on adhesive spot 16, adhesive spot 17 and adhesive spot 18.

FIG. 20 is a perspective view of the bottom side of Edge C, Panel 02 folding over using the five (5) hinges onto adhesive spot 16, adhesive spot 17 and adhesive spot 18.

FIG. 21 is a perspective view of the top side of Edge C, Panel 03 folding over using the eight (8) hinges to complete the folding and application of adhesive to assemble Edge C.

FIG. 22 is a perspective view of the top side of Edge C, Panel 03 locking into place using three (3) tabs to create a rigid flap design that is unique to this disclosure.

FIG. 23 is a perspective view of top side of panel 01, panel 02 and panel 03 for Edge D.

FIG. 24 is a perspective view of adhesive applied to Edge D of the top side of the die cut corrugated sheet to adhesive spot 19, adhesive spot 20 and adhesive spot 21.

FIG. 25 is a perspective view of the bottom side of Edge D, Panel 01 folded over using the eight (8) hinges onto adhesive spot 19, adhesive spot 20 and adhesive spot 21.

FIG. 26 is a perspective view of the adhesive applied to the bottom side of Edge D, Panel 01 on adhesive spot 22, adhesive spot 23 and adhesive spot 24.

FIG. 27 is a perspective view of the bottom side of Edge D, Panel 02 folding over using the five (5) hinges onto adhesive spot 22, adhesive spot 23 and adhesive spot 24.

FIG. 28 is a perspective view of the top side of Edge D, Panel 03 folding over using the eight (8) hinges to complete the folding and application of adhesive to assemble Edge D.

FIG. 29 is a perspective view of the top side of Edge D, Panel 03 locking into place using three (3) tabs to create a rigid flap design that is unique to this disclosure.

FIG. 30 is a perspective view of an assembled corrugated pallet top.

### DETAILED DESCRIPTION

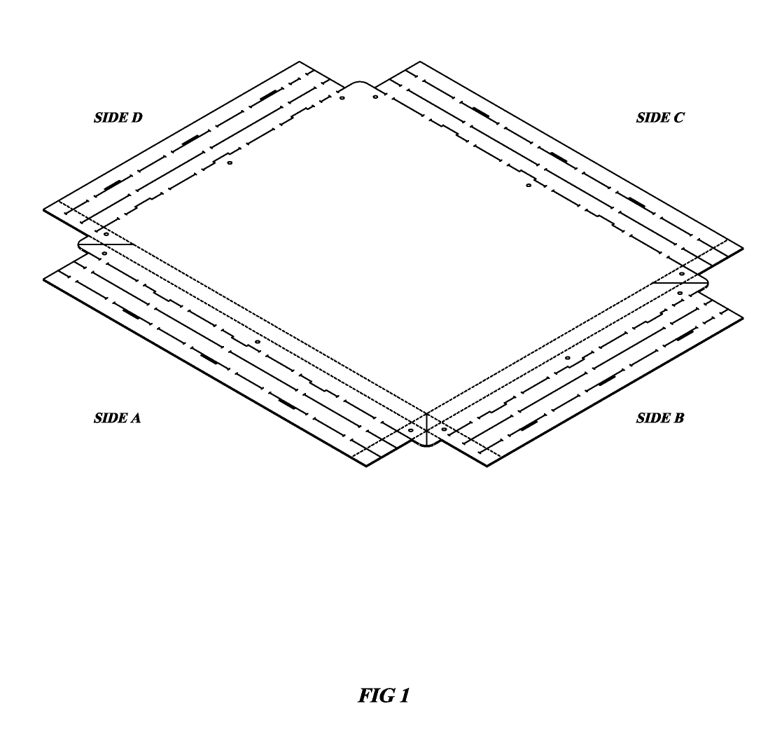

FIG. 01 illustrates a die cut and scored corrugated sheet that forms the basis for the pallet top disclosure. This die cut and scored corrugated sheet represents all of the corrugated material needed for the final pallet top. Die cutting of a corrugated sheet is common in the industry. This one is die cut to specific dimensions to exactly fit the dimensions of the eventual pallet top. The four corners of the corrugated sheet are “rounded” to assist the locking of the disclosure onto a pallet load of product. The corrugated sheet is designed with a perforated feature on two of the four edges to adjust the assembled size of the assembly. The corrugated sheet is designed with die cut holes, hinges and tabs to lock the disclosure together when being used. The corrugated sheet is designed with hinges to allow the use of one sheet that can be folded into separate panels to complete the assembly. The direction of the corrugation for the corrugated sheet is not relevant.

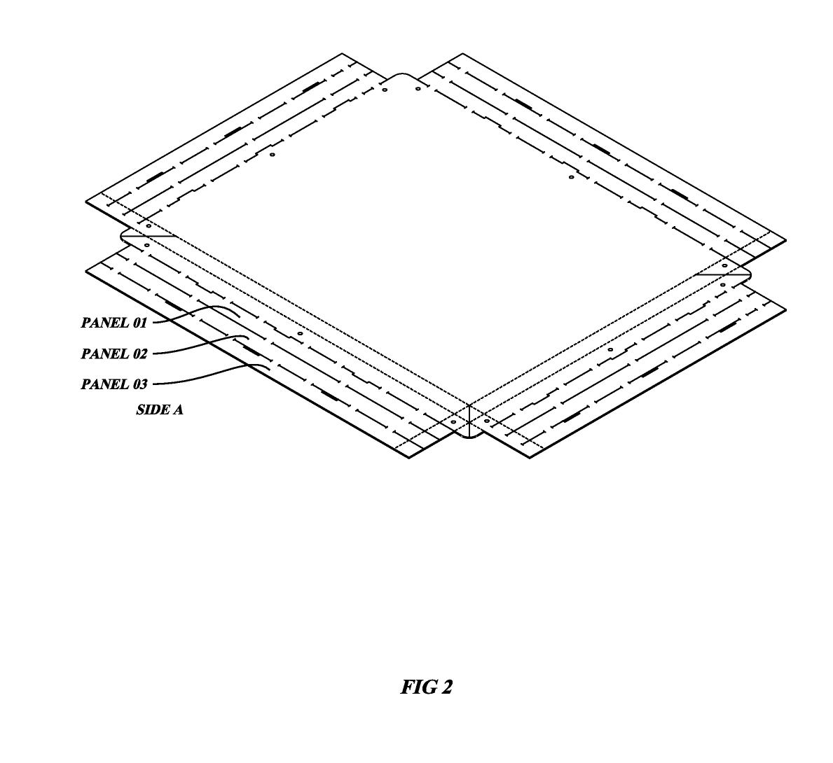

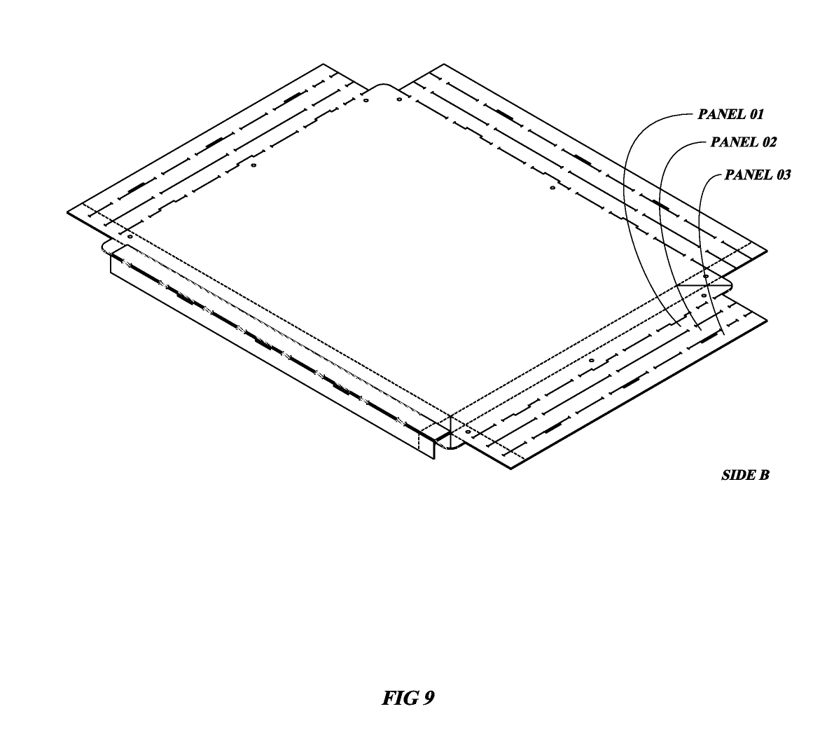

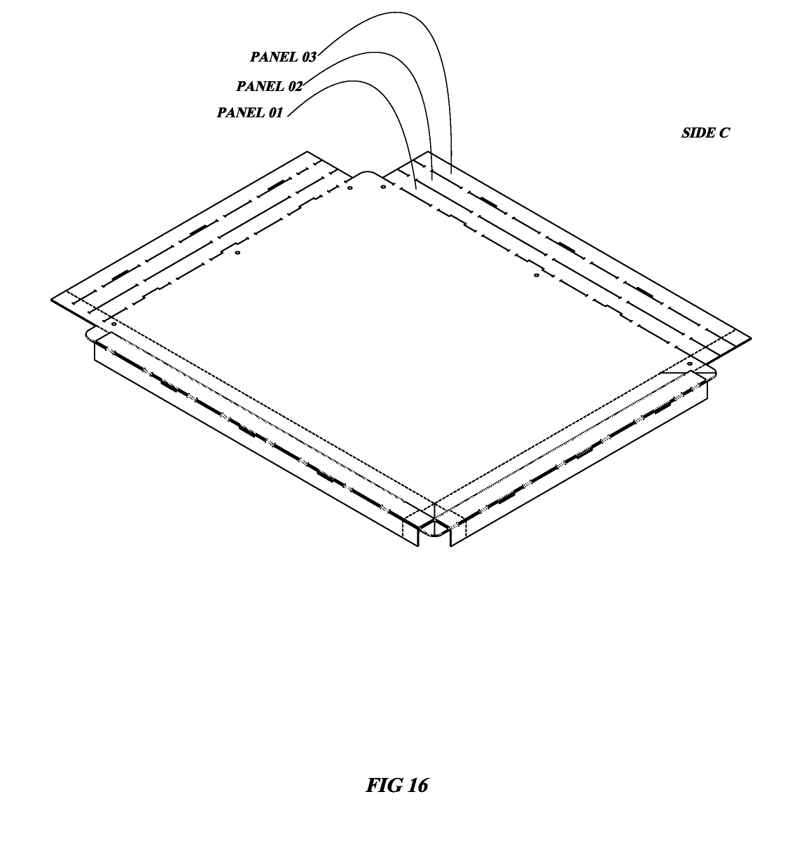

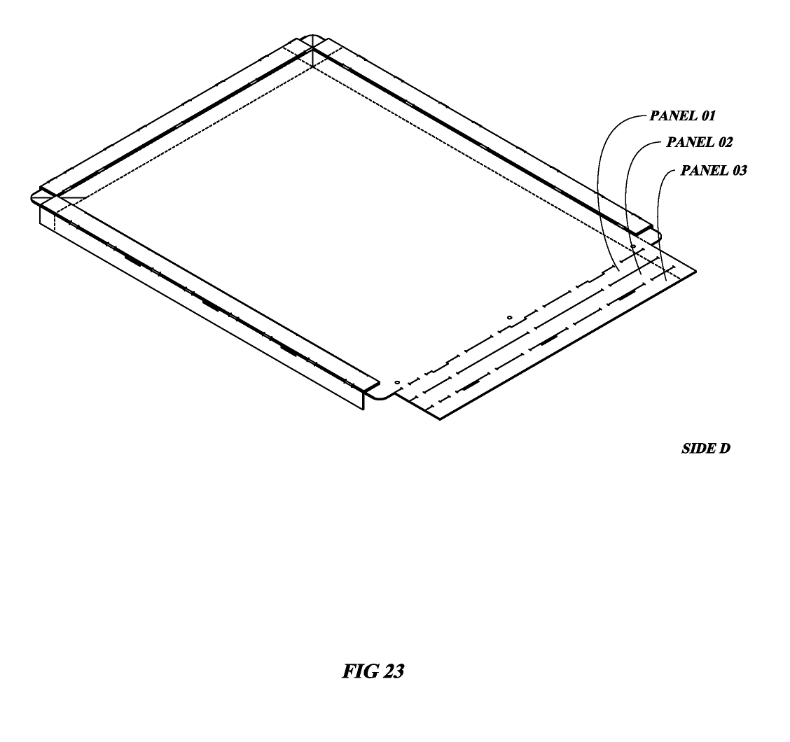

FIGS. 02, 09, 16 and 23 illustrates Panel 01, 02 and 03 on each of the four edges˜Edge A, B, C and D. The specific dimensions of each panel is designed to exactly fit the dimensions of the pallet top.

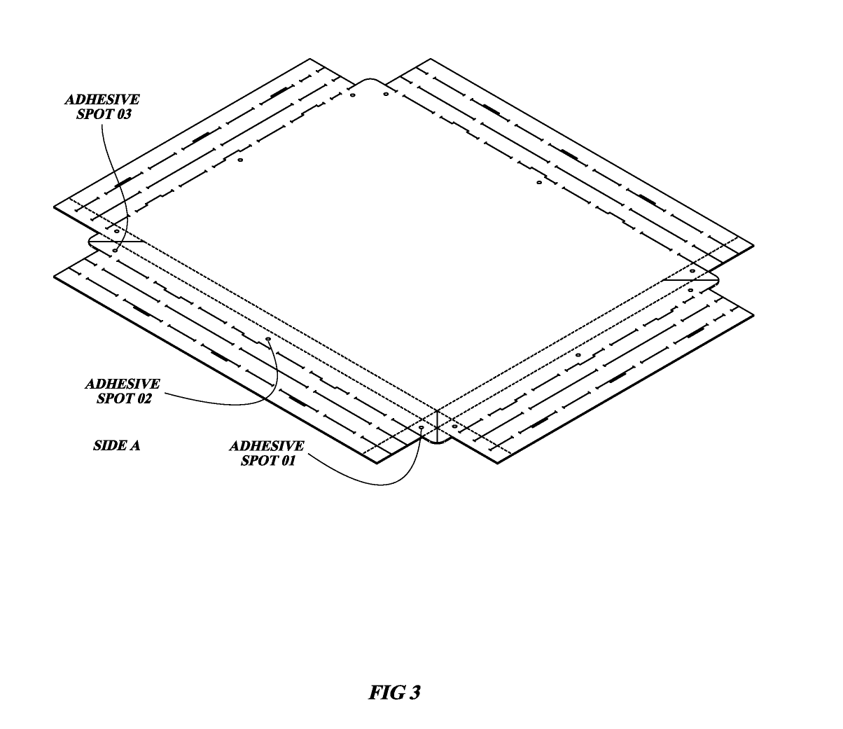

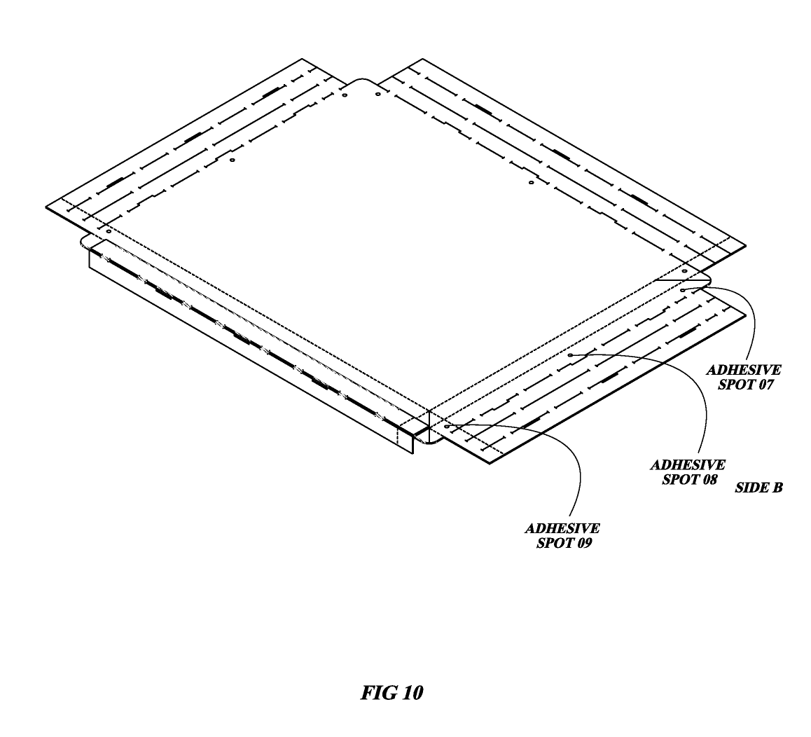

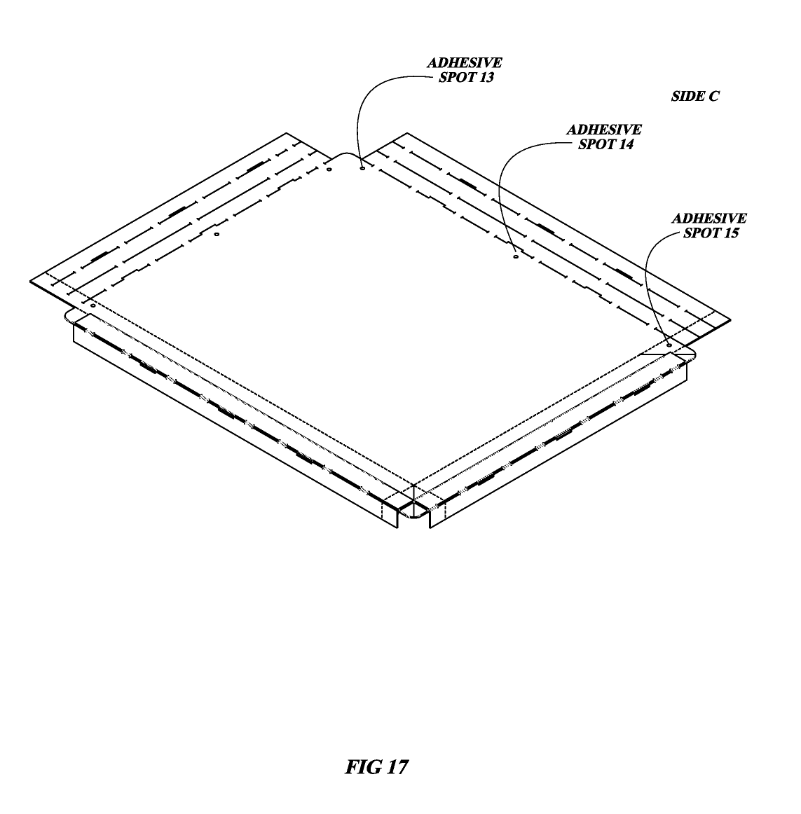

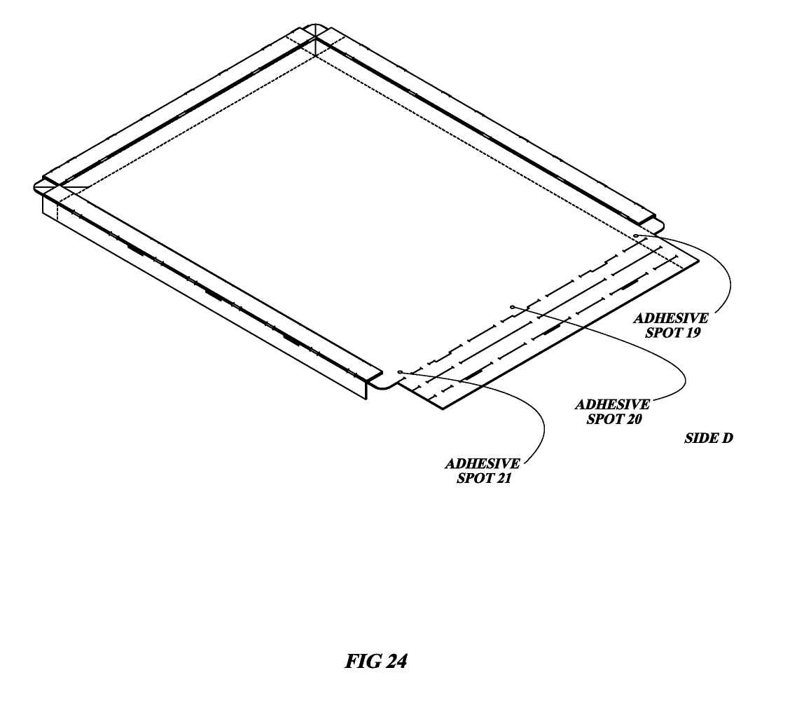

FIGS. 03, 10, 17 and 24 illustrates the four edges and the specific marked adhesive spots referred to as 01, 02, 03, 07, 08, 09, 13, 14, 15, 19, 20 and 21. The sequence is based on three specific marked adhesive spots per edge.

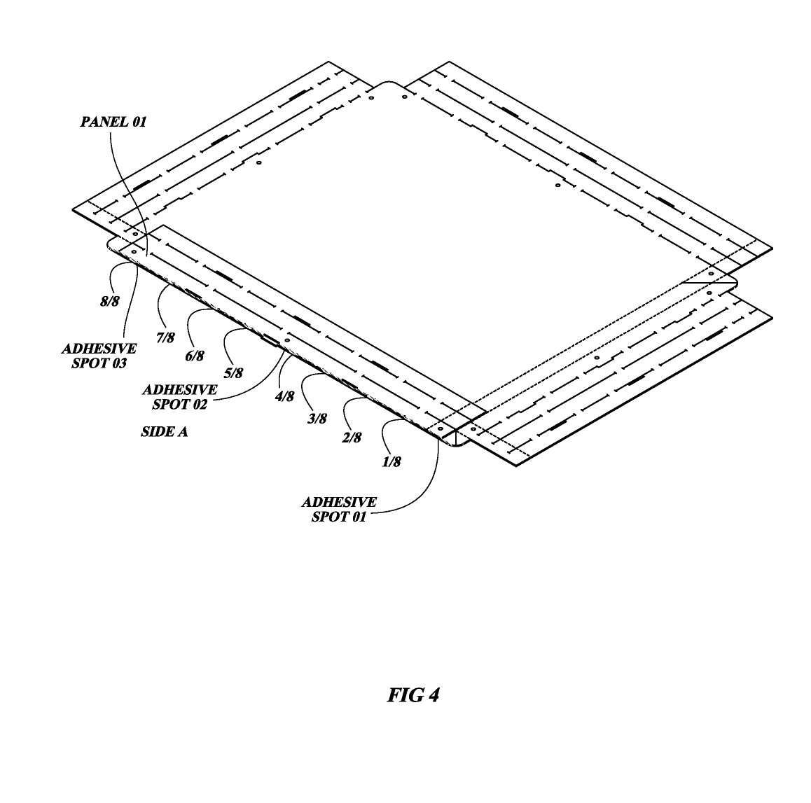

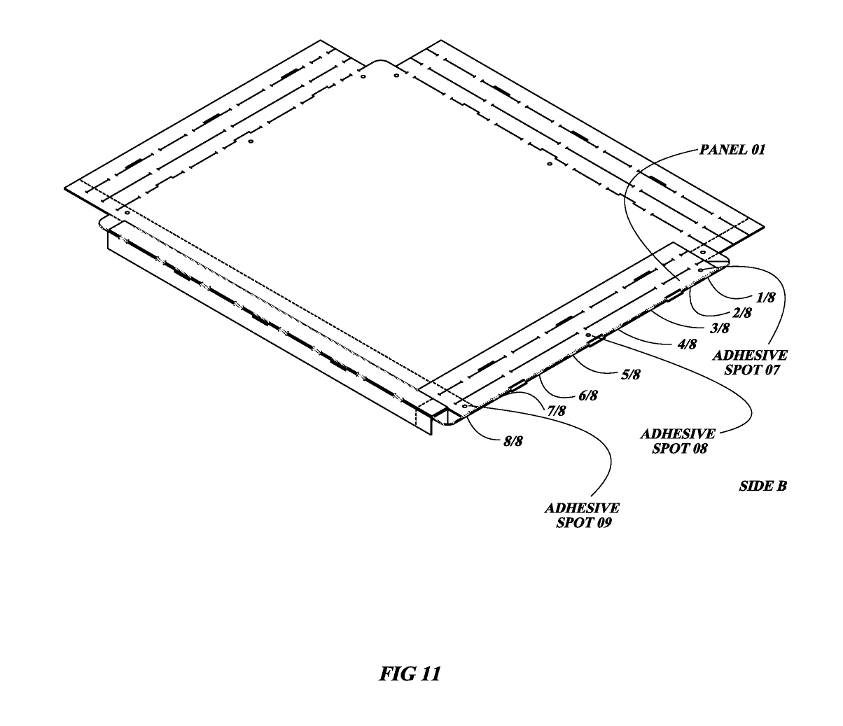

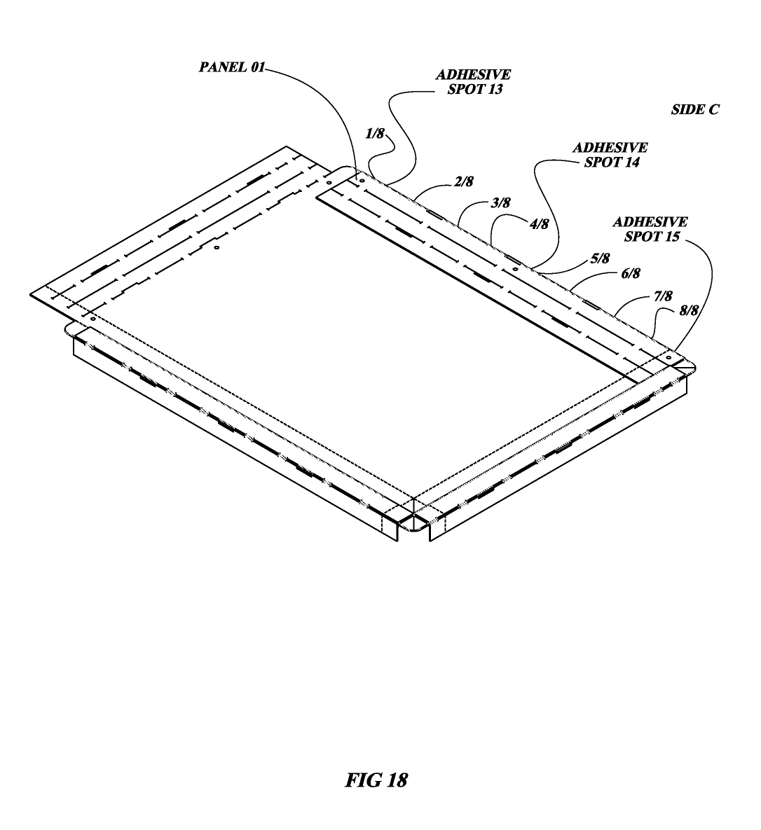

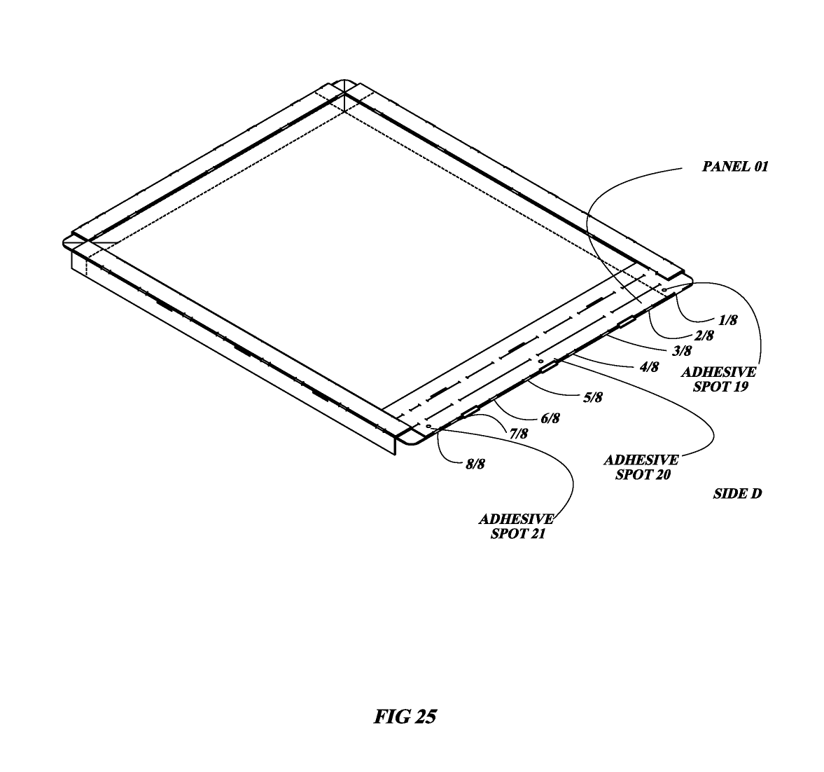

FIGS. 04, 11, 18 and 25 illustrates the bottom side of Edge A, B, C and D being folded using eight (8) hinges so each of the four edges rests on adhesive spot 01, 02, 03, 07, 08, 09, 13, 14, 15, 19, 20 and 21. The specific number of hinges used in this disclosure is adjusted based on the size of the assembled pallet top.

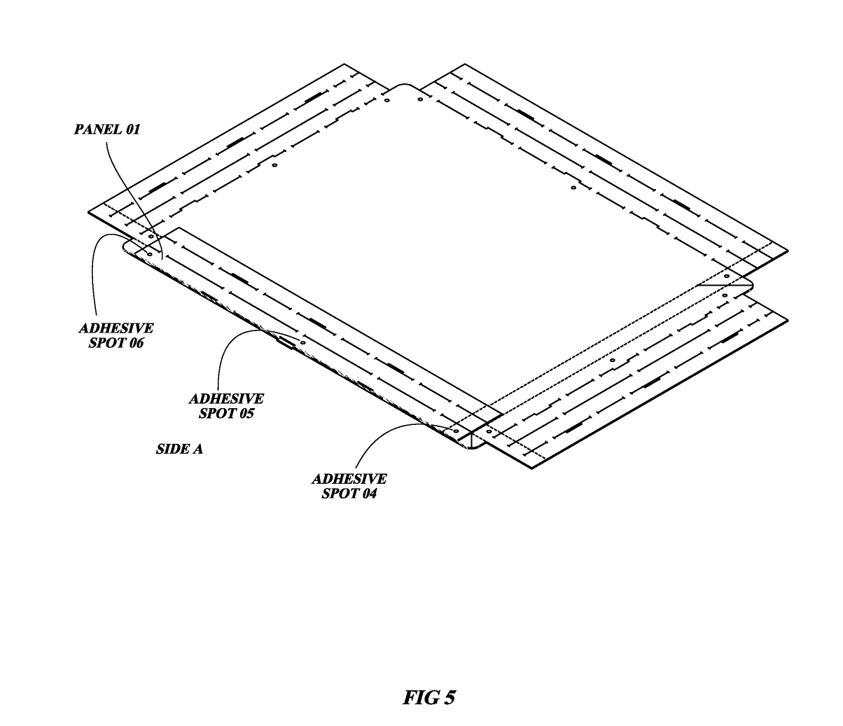

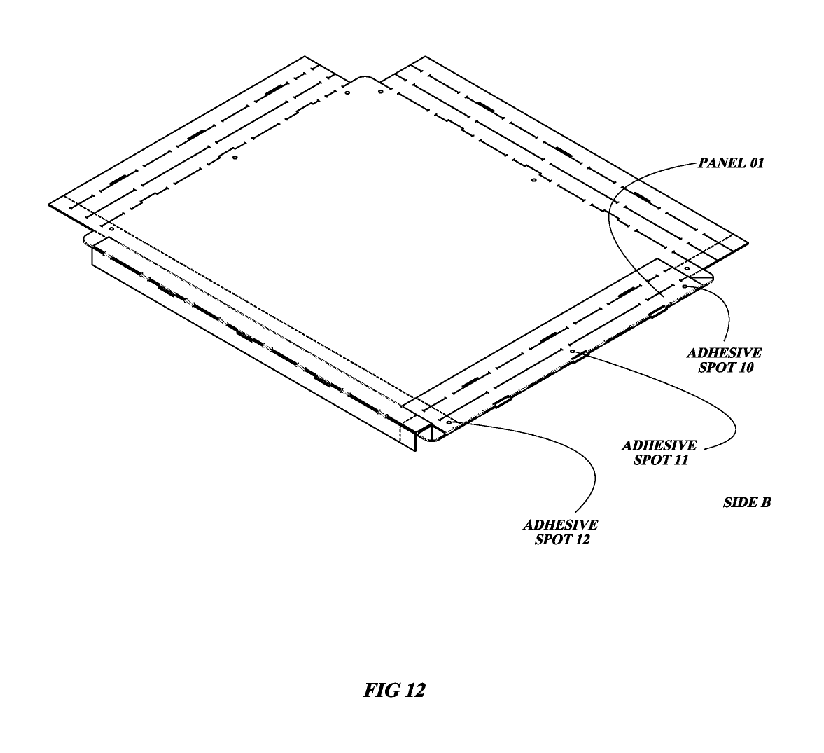

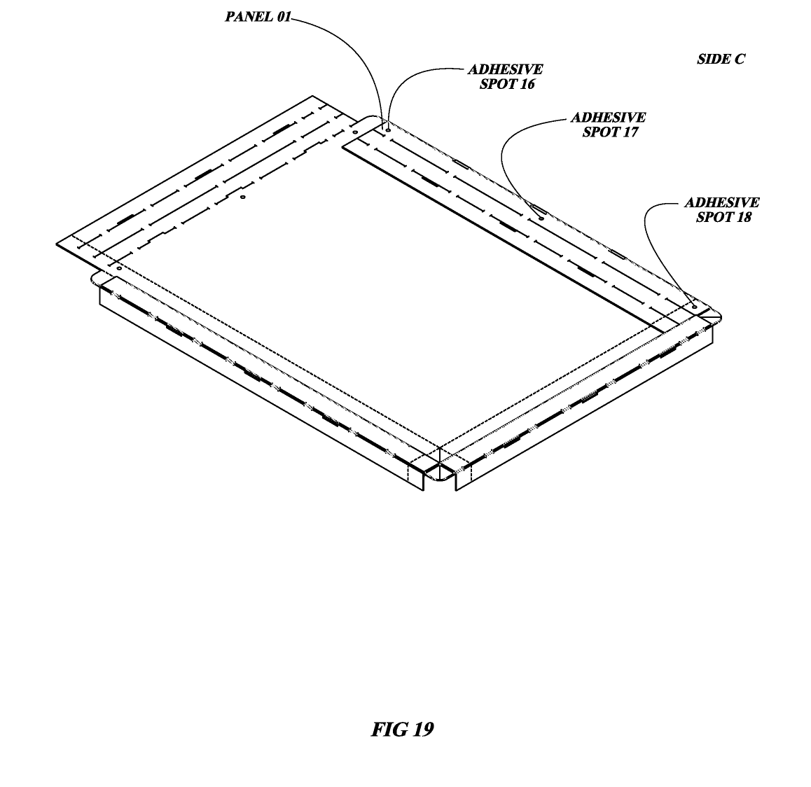

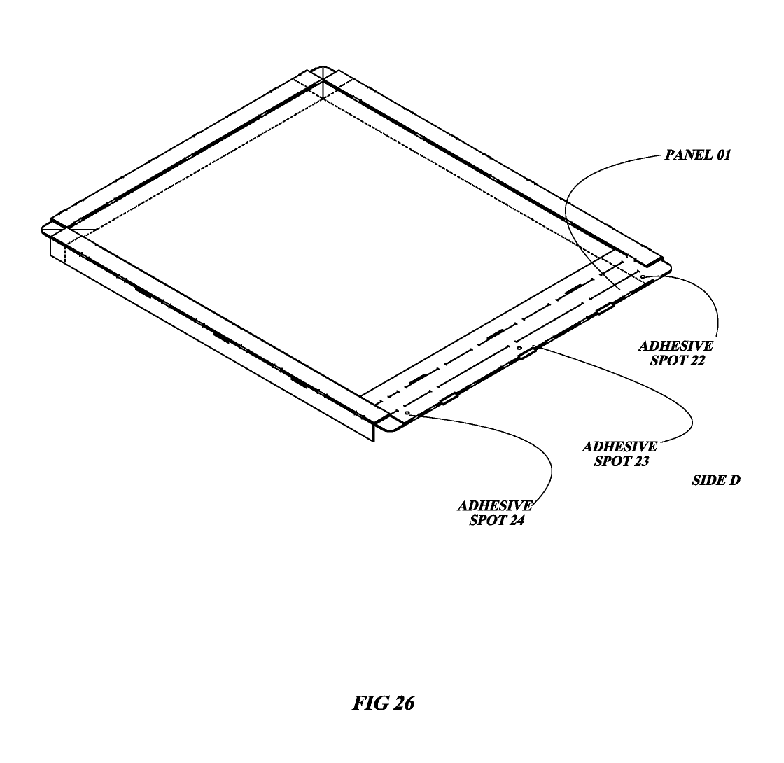

FIGS. 05, 12, 19 and 26 illustrates the bottom side of Panel 01 for Edge A, B, C and D and the specific marked adhesive spots referred to as 04, 05, 06, 10, 11, 12, 16, 17, 18, 22, 23 and 24. The sequence is based on three specific marked adhesive spots per edge.

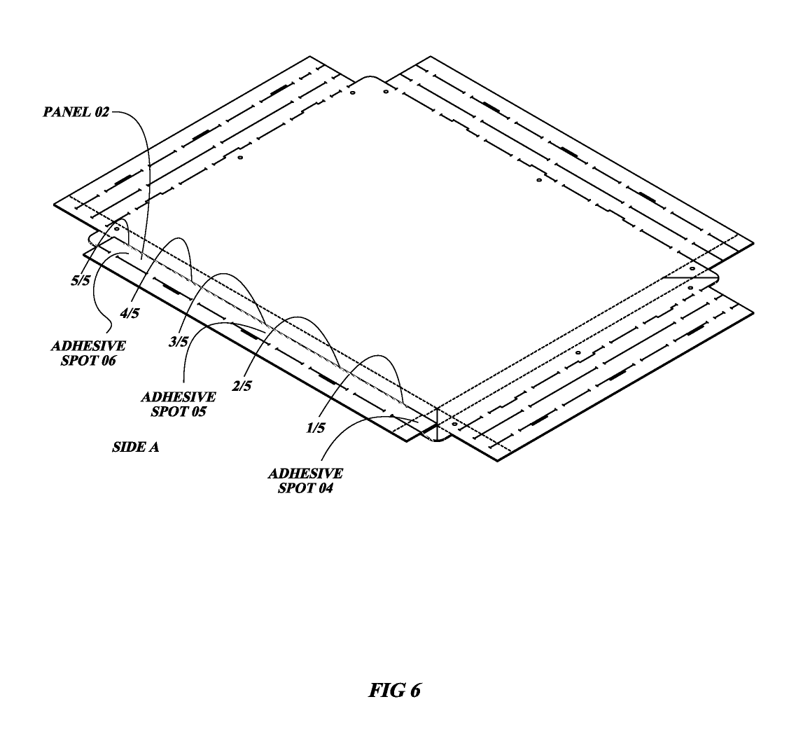

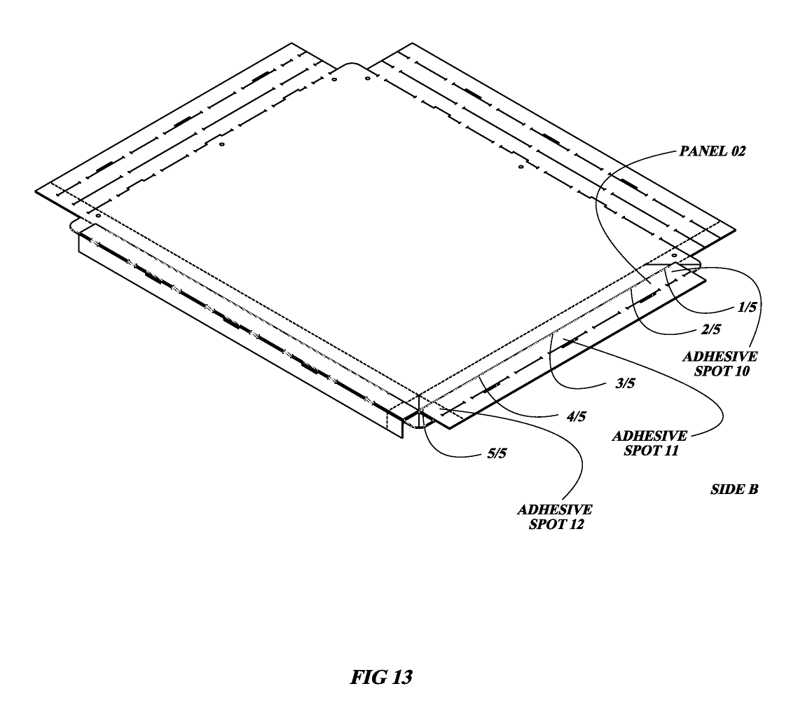

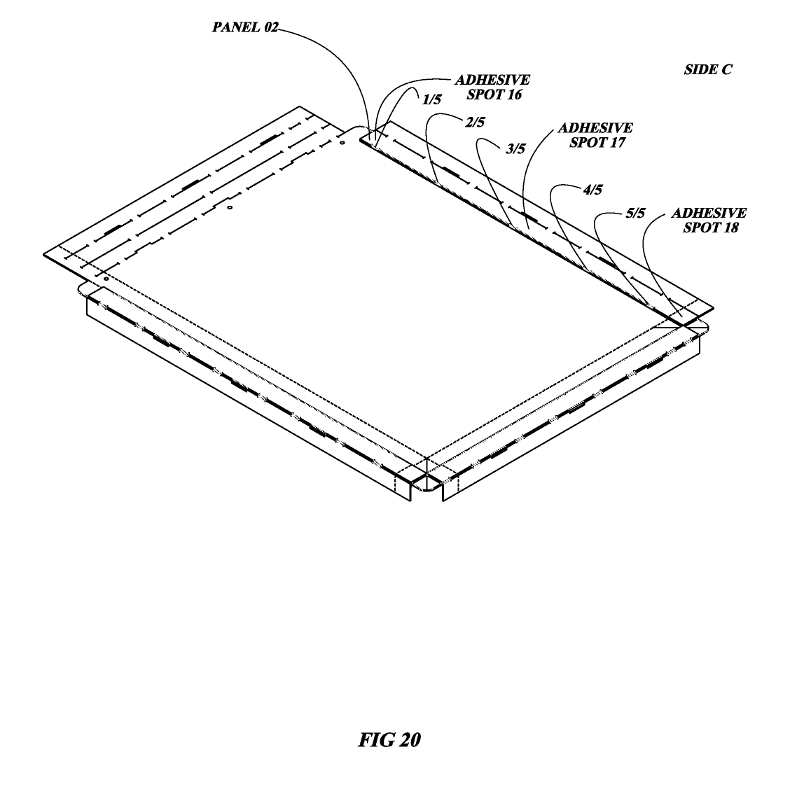

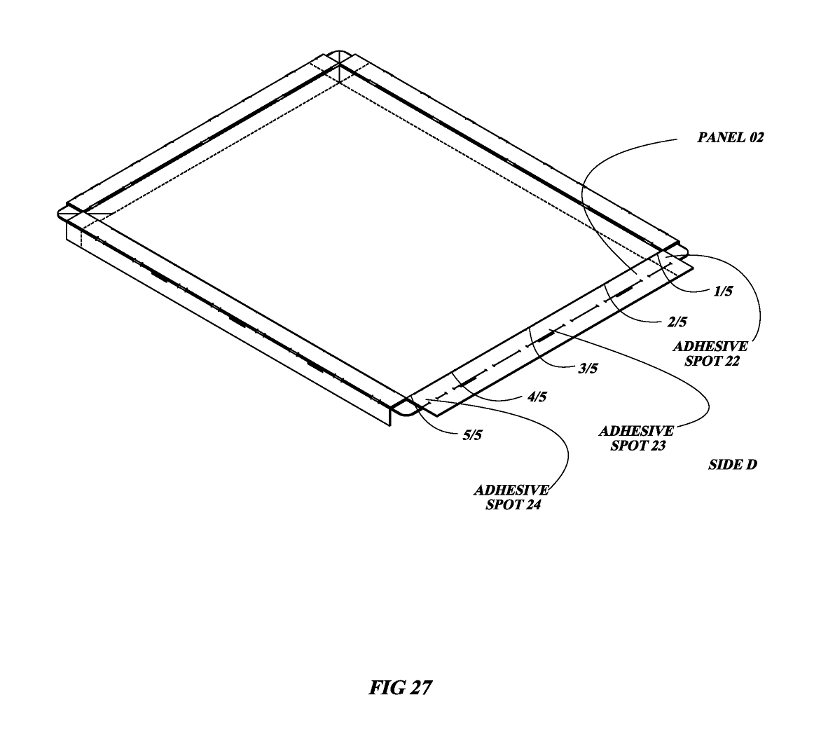

FIGS. 06, 13, 20 and 27 illustrates the bottom side of Panel 02 for Edge A, B, C and D being folded using five (5) hinges so each of the four edges rests on adhesive spot 04, 05, 06, 10, 11, 12, 16, 17, 18, 22, 23 and 24. The specific number of hinges used in this disclosure is adjusted based on the size of the assembled pallet top.

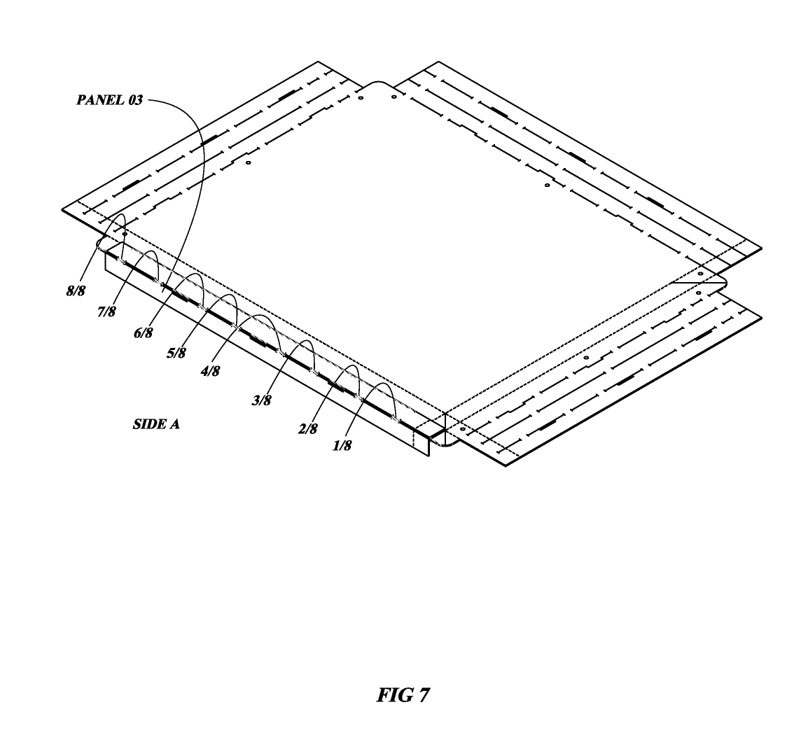

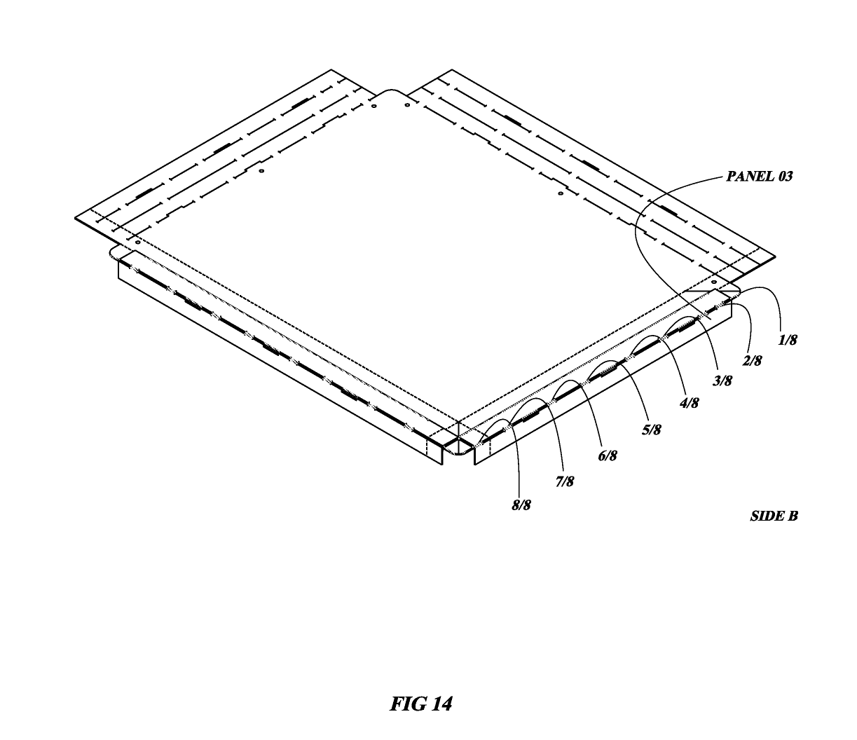

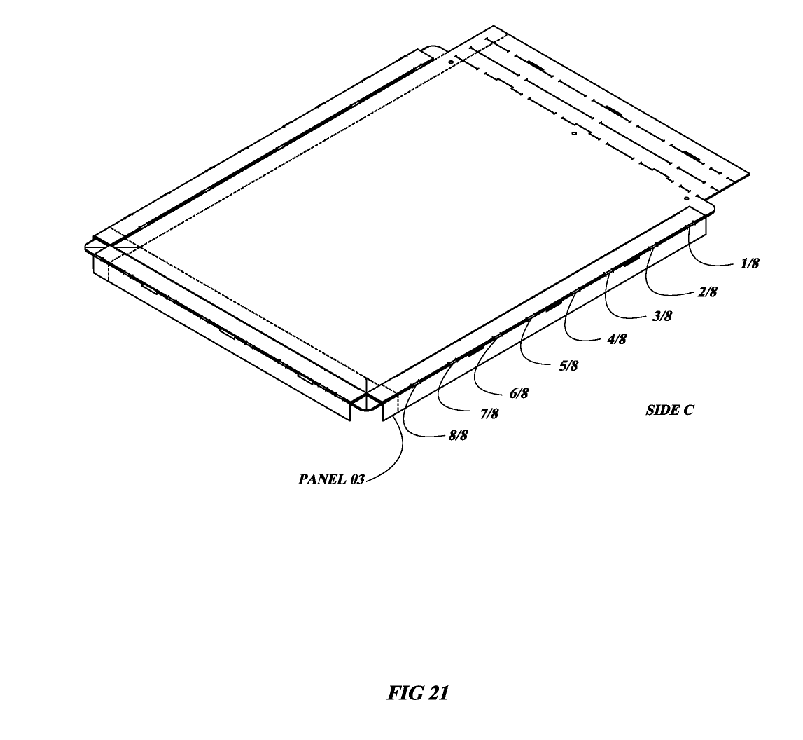

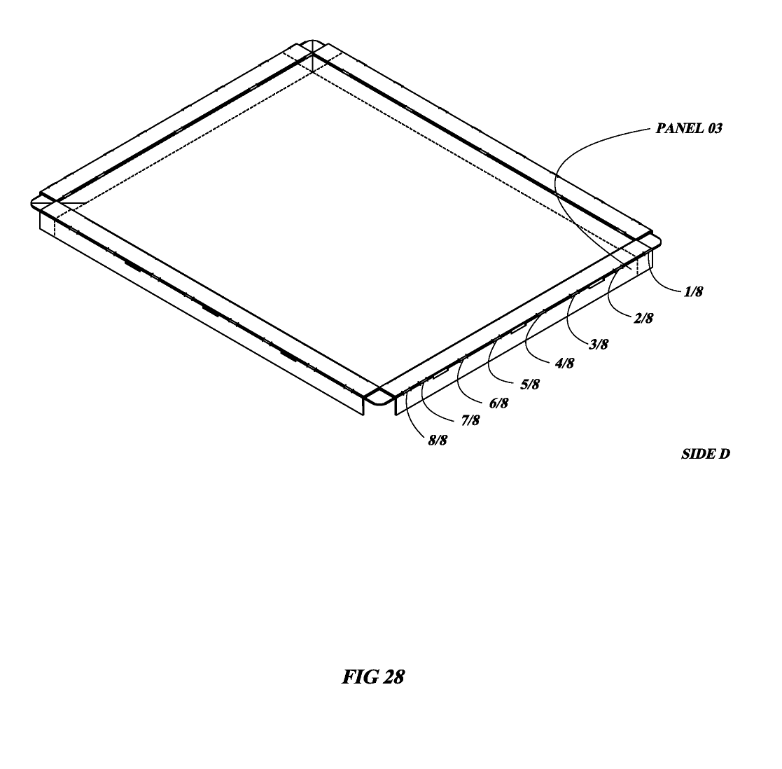

FIGS. 07, 14, 21 and 28 illustrates the top side of Panel 03 for Edge A, B, C and D being folded using eight (8) hinges to complete the folding and application of adhesive to assemble the twelve (12) panels used in this disclosure.

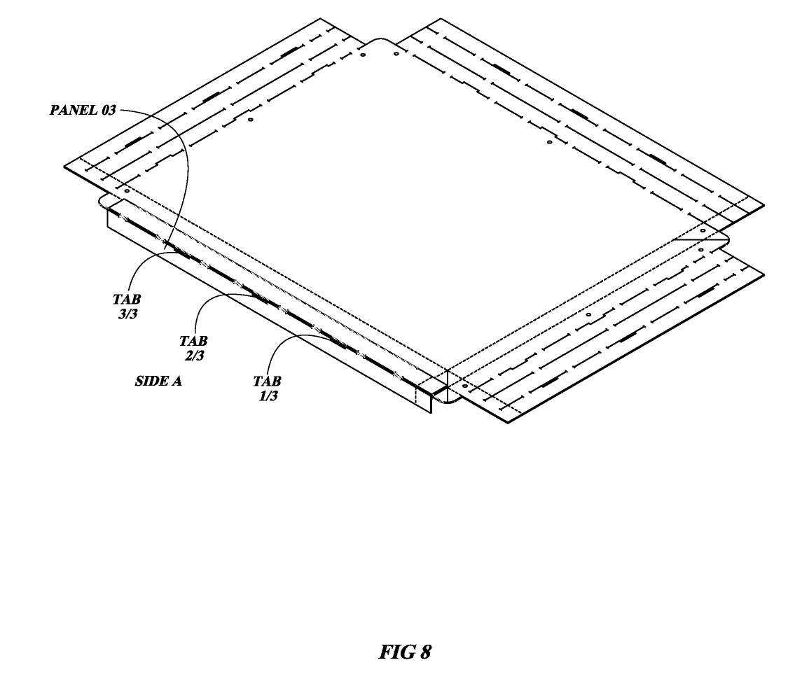

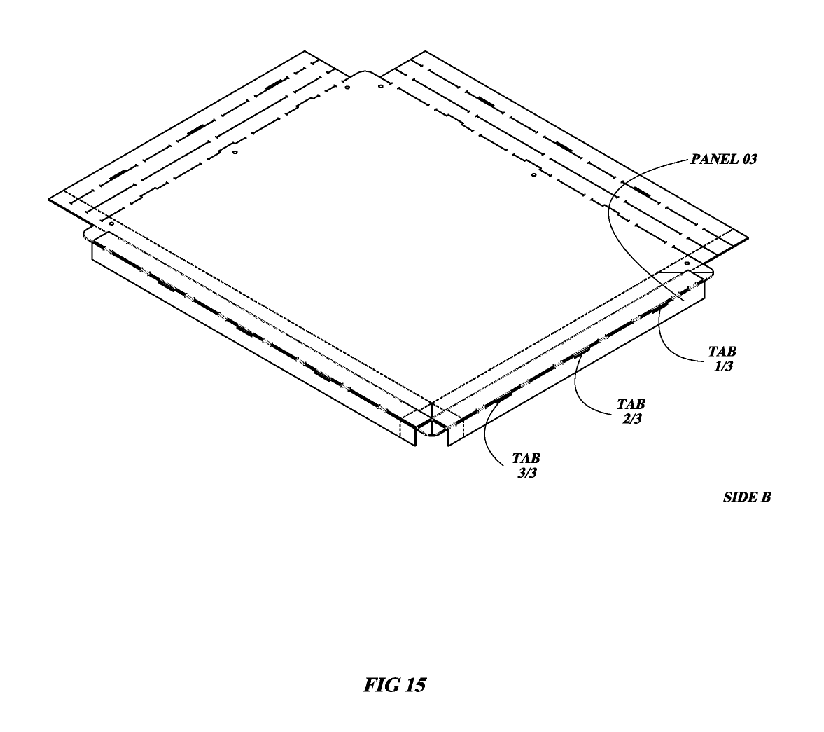

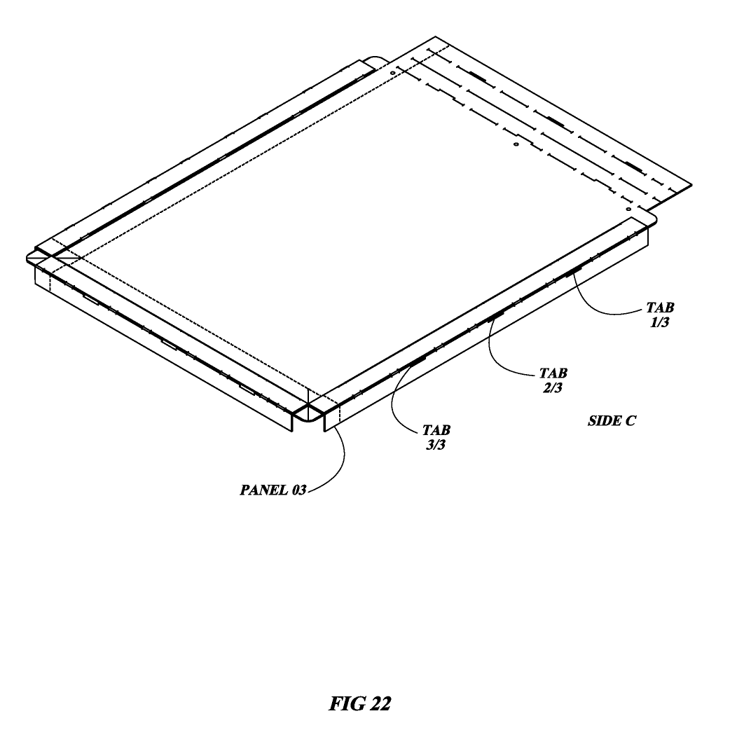

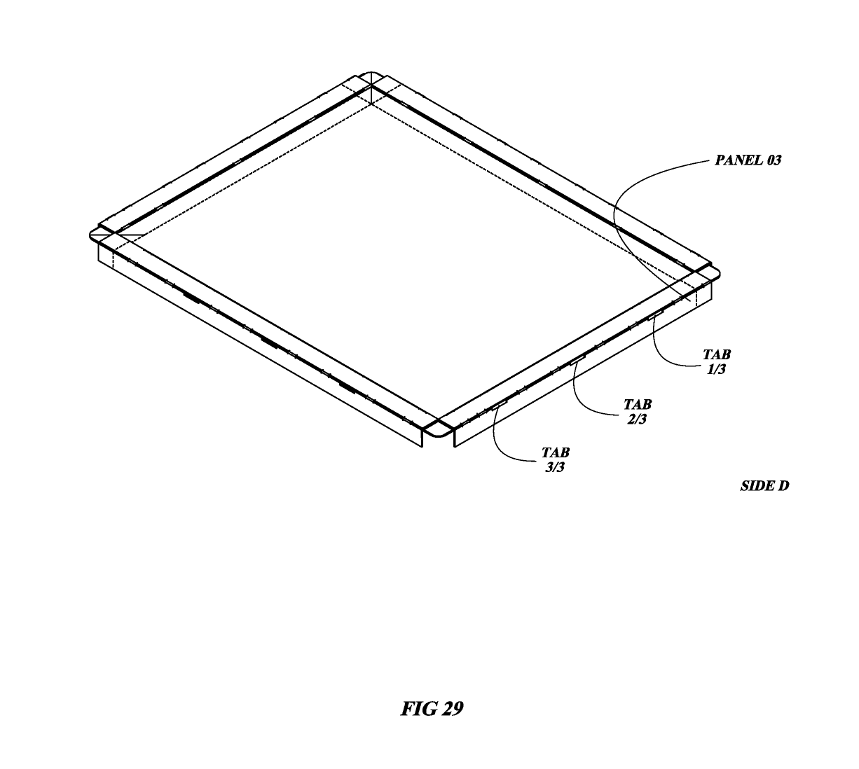

FIGS. 08, 15, 22 and 29 illustrates Panel 03 for Edge A, B, C and D locked into place using the three (3) tabs to create a rigid flap. The specific number of tabs used in this disclosure is adjusted based on the size of the assembled pallet top.

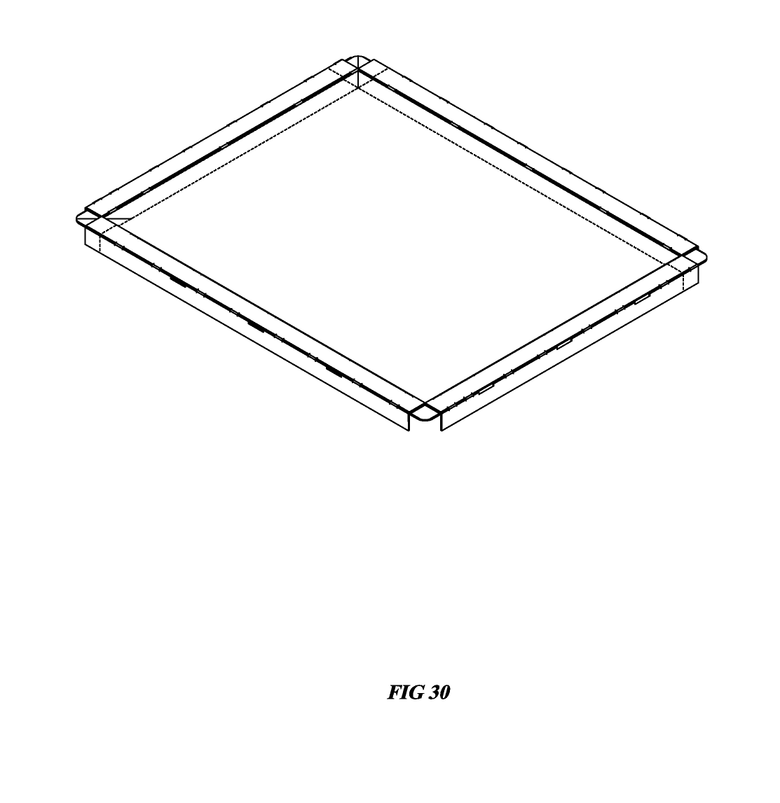

FIG. 30 illustrates the assembled corrugated pallet top disclosure. The disclosure anticipates adjustments to the size of the corrugated sheet, panels, type and amount of adhesive, number, size and location of hinges and the number, size and location of tabs.

The corrugated pallet top can be created as follows. A single rectangular die cut and scored sheet of corrugated material, having four edges, a top side and a bottom side, each edge having marked adhesive spots on the top side; and each edge having corrugated tabs. The single rectangular die cut and scored sheet of corrugated material can have four external and attached sets of panels, one on each external edge of the rectangular die cut and scored sheet of corrugated material, with each of the external sets of panels each having three hinged and foldable panels comprising an innermost panel, a middle panel, and outermost panel, and each of the three hinged and foldable panels having marked adhesive spots on the bottom side of the innermost panel; then for each of the panel sets on the four edges: adhesive can be applied to each of the adhesive spots on the top side. Then each the set of three panels can be folded over the top side using hinges between the innermost panel and the external edge so that the innermost panel is pressed onto the adhesive on the adhesive spots on the top side. Adhesive can then be applied to each of the adhesive spots on the bottom side of the innermost panel and the remaining two panels folded back over the innermost panel using hinges between the innermost panel and the middle panel so that the middle panel is pressed onto the adhesive on the bottom side of the innermost panel. Finally the outermost panel can be folded down at a 90 degree angle with respect to the plane of the single rectangular die cut and scored sheet of corrugated material; and then locked into place using the corrugated tabs along the edge of the single rectangular die cut and scored sheet of corrugated material.

The resulting corrugated pallet top can then be described as corrugated pallet top including at least: a single rectangular die cut and scored sheet of corrugated material, having four edges, a top side and a bottom side, each edge having marked adhesive spots on the top side; and each edge having corrugated tabs; the die cut and scored sheet having four external and attached sets of panels, one on each external edge of the rectangular die cut and scored sheet of corrugated material; the four external sets of panels each having three hinged and foldable panels comprising an innermost panel, a middle panel, and outermost panel; and the three panels on each of the four sets of panels having marked adhesive spots on the bottom side of the innermost panel.

While the disclosure has been described above with reference to specific embodiments thereof, it is apparent that many changes, modifications and variations in the type of corrugated, steps used in the assemble can be made without departing from the inventive concept disclosed herein. Accordingly, the spirit and broad scope of the appended claims are intended to embrace all such changes, modifications and variations that may occur to one of skill in the art upon reading of the disclosure.”

1. A corrugated pallet top comprising:
a. a single rectangular die cut and scored sheet of corrugated material, having four edges, a top side and a bottom side, each edge having marked adhesive spots on the top side; and each edge having corrugated tabs;
b. said die cut and scored sheet having four external and attached sets of panels, one on each external edge of the rectangular die cut and scored sheet of corrugated material;
c. said four external sets of panels each having three hinged and foldable panels comprising an innermost panel, a middle panel, and outermost panel; and
d. said three panels on each of the four sets of panels having marked adhesive spots on the bottom side of the innermost panel.

2. The corrugated pallet top of claim 1 wherein the specific number of hinges used is adjusted based on the size of the assembled pallet top.

3. The corrugated pallet top of claim 1 wherein the specific number of tabs used is adjusted based on the size of the assembled pallet top.

4. The corrugated pallet top of claim 1 wherein the four corners of the single rectangular die cut and scored sheet of corrugated material are rounded.

5. A method for creating a corrugated pallet top comprising:
a. providing a single rectangular die cut and scored sheet of corrugated material, having four edges, a top side and a bottom side, each edge having marked adhesive spots on the top side; and each edge having corrugated tabs;
b. providing four external and attached sets of panels, one on each external edge of the rectangular die cut and scored sheet of corrugated material, with each of the external sets of panels each having three hinged and foldable panels comprising an innermost panel, a middle panel, and outermost panel, and each of the three hinged and foldable panels having marked adhesive spots on the bottom side of the innermost panel; and
c. then for each of the panel sets on the four edges:
i. applying adhesive to each of the adhesive spots on the top side;
ii. folding the set of three panels over the top side using hinges between the innermost panel and the external edge so that the innermost panel is pressed onto the adhesive on the adhesive spots on the top side;
iii. applying adhesive to each of the adhesive spots on the bottom side of the innermost panel;
iv. folding the remaining two panels back over the innermost panel using hinges between the innermost panel and the middle panel so that the middle panel is pressed onto the adhesive on the bottom side of the innermost panel;
v. folding the outermost panel down at a 90 degree angle with respect to the plane of the single rectangular die cut and scored sheet of corrugated material; and
vi. locking the outermost panel into place using the corrugated tabs along the edge of the single rectangular die cut and scored sheet of corrugated material.

6. The method for creating a corrugated pallet top of claim 4 wherein the specific number of tabs used is adjusted based on the size of the assembled pallet top.

7. The method for creating a corrugated pallet top of claim 4 wherein the specific number of hinges used is adjusted based on the size of the assembled pallet top.
